(19) United States
(12) Patent Application Publication
(10) Pub. No.: US 2026/0320045 A1
(43) Pub. Date: Oct. 15, 2026

(54) QUERY CACHE MANAGEMENT WITH REPETITION GRADUATION AND INVALIDATION OPTIMIZATION

(71) Applicant: CAST AI Group, Inc., Miami, FL (US)

(72) Inventors: Benjamin Gray, Reading (GB); Luka Androjna, Ljubljana (SI); Viktoras Makauskas, Vilnius (LT)

(21) Appl. No.: 19/641,385

(22) Filed: Apr. 7, 2026

Related U.S. Application Data
(60) Provisional application No. 63/785,695, filed on Apr. 9, 2025.

(51) Int. Cl. G06F 16/2453; G06F 16/22; G06F 16/2455

(52) U.S. Cl. CPC G06F 16/24539; G06F 16/221; G06F 16/24552

(57) ABSTRACT

A query cache management system that comprises a query cache configured to store query results and query hashes for queries that have been executed multiple times; a processor in communication with the query cache and configured to: receive database queries; and perform, for each database query received: normalize the database query to generate a query hash, determine whether the query hash exists in the query cache, retrieve an associated query result stored in the query cache in response to determining the query hash exists in the query cache, determine whether the query hash exists in a candidate list structure in response to determining the query hash does not exist in the query cache, wherein the candidate list structure is configured to store query hashes for queries that have only been executed once.

### CROSS-REFERENCE TO RELATED APPLICATIONS

This application claims priority under 35 USC §119(e) to U.S. Provisional Application No. 63/785,695, filed on Apr. 9, 2025, the contents of which is incorporated herein by reference in its entirety.

### BACKGROUND

### Field

The present disclosure relates to database query caching systems, and more particularly to a query cache management system that uses repetition graduation to separate one-time queries from repeating queries and optimizes cache invalidation through improved query analysis and long-term statistical data.

### Related Art

Database query caching systems are widely used to improve the performance of database applications by storing the results of frequently executed queries in cache memory. When a query is executed, the system first checks if the result is available in the cache, and if so, returns the cached result/entry instead of executing the query against the database. This approach can substantially reduce query execution time and database load, particularly for applications that execute similar queries repeatedly.

Traditional query caching systems typically employ Least Recently Used (LRU) cache management strategies, where queries are added to the cache upon first execution and are evicted when the cache reaches capacity or upon satisfaction of expiration criteria associated with cached results. However, these conventional approaches face several challenges in real-world database environments. Many database applications generate a significant number of one-time queries that are executed only once and never repeated. These single-use queries consume cache space and processing resources without providing any caching benefit, as they are never accessed again after their initial execution.

The presence of one-time queries in the cache creates multiple inefficiencies. First, these queries occupy valuable cache space that could otherwise be used for other queries that would benefit from caching (e.g., queries that are repeatedly submitted to the database). Second, with regard to LRU cache management systems, when one-time queries fill the cache, database query caching systems will evict other queries that may be repeated, leading to cache misses for queries that would otherwise hit the cache. Lastly, cache invalidation processes, which determine when cached query results are no longer valid due to underlying data changes, must examine all cached queries including the one-time queries, resulting in unnecessary computational overhead.

Cache invalidation presents additional complexity in query caching systems. When data modification queries are executed, the system must determine which cached query results may have been affected and invalidate them to maintain data consistency. This process typically involves analyzing the columns and conditions accessed by both the data modification query and each cached query to determine potential overlaps. The invalidation analysis must be performed for all queries in the cache, including those that may never be executed again, creating computational waste.

Furthermore, traditional caching systems make decisions based solely on recent query activity observed in the current cache state, without leveraging historical patterns or long-term statistical data about query behavior. This limited perspective can result in suboptimal caching decisions, as the system lacks insight into broader query patterns that could inform better cache management strategies.

### SUMMARY

In an embodiment, a query cache management system comprises a query cache configured to store query results and query hashes for queries that have been executed multiple times; and a processor in communication with the query cache, wherein the processor is configured to: receive database queries; and perform, for each database query received: normalize the database query to generate a query hash, determine whether the query hash exists in the query cache, retrieve an associated query result stored in the query cache in response to determining the query hash exists in the query cache, determine whether the query hash exists in a candidate list structure in response to determining the query hash does not exist in the query cache, wherein the candidate list structure is configured to store query hashes for queries that have only been executed once, and add the database query and the associated query result to the query cache in response to determining that the query hash exists in the candidate list structure, and retrieve the associated query result.

The processor may be further configured to add the database query and the query hash to the candidate list structure in response to determining that the query hash does not exist in the candidate list structure.

The candidate list structure may comprise a bloom filter or a hash map.

The candidate list structure may comprise a secondary cache.

The secondary cache may be configured to automatically evict stored query hashes according to a time-to-live value.

The processor may be further configured to determine whether the database query is a data modification query; compare accessed data columns between the database query and queries cached in the query cache in response to determining the database query is a data modification query; and invalidate query results of one or more queries cached in the query cache in response to determining overlap in accessed data columns between the database query and the one or more queries.

The processor may be further configured to determine whether the database query modifies query results of one or more queries cached in the query cache; and invalidate the query results of the one or more queries in response to determining that the database query modifies the query results of the one or more queries.

In an embodiment, a query cache management system comprises a query cache configured to store query results and query hashes for queries that have been executed multiple times; and a processor in communication with the query cache, wherein the processor is configured to: receive database queries; perform, for each database query received: determine whether the database query is a data modification query; compare accessed data columns between the database query and the queries cached in the query cache in response to determining the database query is a data modification query; and invalidate query results of one or more queries cached in the query cache in response to determining overlap in accessed data columns between the database query and the one or more queries.

The processor may be further configured to normalize the database query to generate a query hash; determine whether the query hash exists in the query cache; retrieve an associated query result stored in the query cache in response to determining the query hash exists in the query cache; determine whether the query hash exists in a candidate list structure in response to determining the query hash does not exist in the query cache, wherein the candidate list structure is configured to store query hashes for queries that have only been executed once; and add the database query and the associated query result to the query cache in response to determining that the query hash exists in the candidate list structure, and retrieve the associated query result.

The processor may be further configured to add the database query and the query hash to the candidate list structure in response to determining that the query hash does not exist in the candidate list structure.

The candidate list structure may comprise a bloom filter or a hash map.

The candidate list structure may comprise a secondary cache.

The secondary cache may be configured to automatically evict stored query hashes according to a time-to-live value.

In an embodiment, a query cache optimization method comprises collecting and aggregating, by a processor, template-level statistics for queries stored in a query cache; analyzing, by the processor, the template-level statistics to generate one or more eviction rules; and performing, by the processor, query evictions to evict one or more queries of the queries based on the one or more query eviction rules.

The collecting and aggregating the template-level statistics for the queries stored in the query cache may comprise: generating a plurality of query hashes from the queries, each query hash corresponds to a query stored in the query cache; and aggregating the plurality of query hashes into a plurality of templates based on structural similarities between query hashes.

The collecting and aggregating the template-level statistics for the queries stored in the query cache further comprise calculating, for each template of the plurality of templates, average query repetitions for each query within the template, wherein the one or more query eviction rules comprise performance of query eviction on a query where average query repetitions for the query is below a threshold repetitions level of a template that the query is associated with.

The collecting and aggregating the template-level statistics for the queries stored in the query cache may further comprise calculating, for each template of the plurality of templates, maximum query repetitions for each query within the template, wherein the one or more query eviction rules comprise performance of query eviction on a query where maximum query repetitions for the query exceeds a threshold repetitions value of a template that the query is associated with.

The collecting and aggregating the template-level statistics for the queries stored in the query cache may further comprise calculating, for each template of the plurality of templates, average time between query executions for each query within the template, wherein the one or more query eviction rules comprise performance of query eviction on a query where average time between query executions for the query exceeds a time threshold of a template that the query is associated with.

The collecting and aggregating the template-level statistics for the queries stored in the query cache may further comprise calculating, for each template of the plurality of templates, maximum time between query executions for each query within the template, wherein the one or more query eviction rules comprise performance of query eviction on a query where maximum time between query executions for the query exceeds a time threshold of a template that the query is associated with.

The query evictions may be performed during invalidation scans to reduce computational overhead.

### BRIEF DESCRIPTION OF DRAWINGS

A general architecture that implements the various features of the disclosure will now be described with reference to the drawings. The drawings and the associated descriptions are provided to illustrate example embodiments of the disclosure and not to limit the scope of the disclosure. Throughout the drawings, reference numbers are reused to indicate correspondence between referenced elements.

FIG. 1 illustrates an example query cache management system 100 in accordance with some embodiments described herein.

FIG. 2 illustrates an example query cache handling process 200 in accordance with some embodiments described herein.

FIG. 3 illustrates an example query invalidation process 300 in accordance with some embodiments described herein.

FIG. 4 illustrates an example query eviction process 400 in accordance with some embodiments described herein.

FIGS. 5A-5D illustrate example eviction results in accordance with some embodiments described herein.

FIG. 6 illustrates an example computing environment with an example computer device suitable for use in some example embodiments.

### DETAILED DESCRIPTION

The following detailed description provides details of the figures and example embodiments of the present application. Reference numerals and descriptions of redundant elements between figures are omitted for clarity. Terms used throughout the description are provided as examples and are not intended to be limiting. For example, the use of the term “automatic” may involve fully automatic or semi-automatic embodiments involving user or administrator control over certain aspects of the embodiment, depending on the desired embodiment of one of the ordinary skills in the art practicing embodiments of the present application. Selection can be conducted by a user through a user interface or other input means, or can be implemented through a desired algorithm. Example embodiments as described herein can be utilized either singularly or in combination and the functionality of the example embodiments can be implemented through any means according to the desired embodiments.

The examples and embodiments described herein are provided for illustrative purposes only and are not intended to limit the scope of the subject matter. Certain details or components may be omitted where they are well-understood by those skilled in the art, and the described subject matter may be implemented in various configurations or arrangements without departing from its scope. Modifications, substitutions, or rearrangements of the described features and processes are contemplated and fall within the spirit and scope of the subject matter as defined by the claims.

The existing query caching system constructs and maintains a data query language (DQL) least-recently-used (LRU) cache using only short-term observations of currently processed traffic. Because cache admission decisions are made incrementally without incorporating longer-term workload behavior, the cache often becomes populated with a large number of queries that are executed only once. These one-time queries occupy cache space despite providing no reuse benefit and contribute to unnecessary processing overhead. The inefficiency becomes particularly pronounced during query invalidation. Whenever a data manipulation language (DML) query is executed, the system performs a full scan of the DQL cache to determine which cached queries might be affected by the modification. The invalidation process involves comparing accessed columns and evaluating query conditions between the DML query and each cached DQL query in order to detect possible intersections in the underlying data. Because the cache may contain many one-time queries that will never be reused, the system repeatedly performs expensive comparisons and invalidations on entries that provide little or no performance benefit. As a result, the presence of these low-value cache entries increases CPU overhead, slows invalidation scans, and reduces overall cache efficiency.

The present detailed description provides illustrative embodiments of systems, methods, and computer-readable media for query cache management and optimization in database system to address these inefficiencies. The system introduces mechanisms for improving both the construction and maintenance of the query cache by incorporating long-term workload observations derived from stored query telemetry. Template-level statistics are periodically aggregated from historical query data, including metrics such as the average and maximum number of repetitions per query template and the average and maximum time between query occurrences, and used to guide cache management decisions. Using these template-level insights, the system can selectively omit caching queries associated with templates that rarely repeat, thereby preventing low-value queries from entering the cache.

Further improvements are introduced through a repetition graduation mechanism that prevents new queries from being immediately inserted into the query cache. When a query hash is observed for the first time, it is placed into a temporary candidate or quarantine structure rather than the primary cache. Only if the same query hash appears again is the query promoted into the cache, thereby ensuring that only repeating queries consume cache space. This isolates one-hit queries and prevents them from displacing frequently repeated queries within the LRU structure. By combining template-based workload analytics, repetition-aware cache admission, and periodic cache cleanup, the system reduces the number of unnecessary cache entries and significantly decreases the amount of scanning and comparison work required during invalidation operations, resulting in improved cache efficiency, reduced memory usage, and faster query processing.

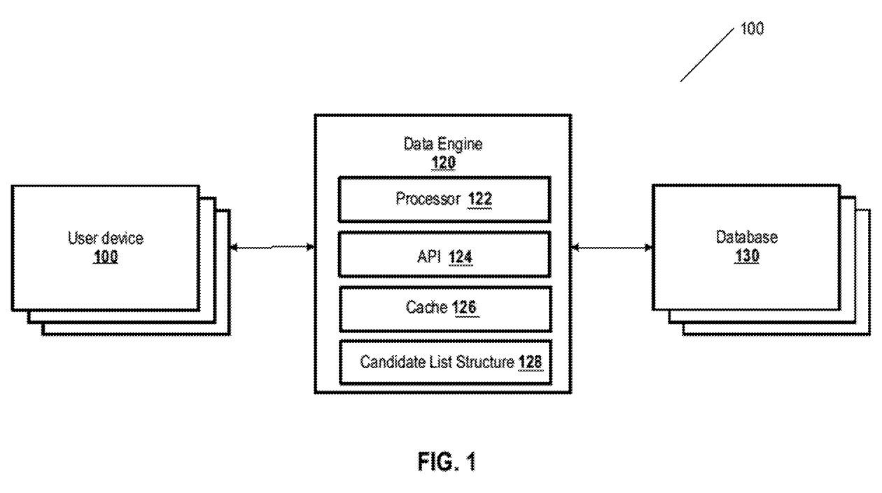

FIG. 1 illustrates an example query cache management system 100 in accordance with some embodiments described herein. As illustrated in FIG. 1, the query cache management system 100 may include components such as, but not limited to, one or more user devices 110, a data engine 120, a database 130, etc. The one or more user devices 110 communicates with the data engine 120 and the database 130 via one or more networks. In particular, the one or more user devices may issue application programming interface (API) calls requesting data operations to the data engine 120 and the database 130 via one or more networks to access stored data or triggering other data functions/operations. The one or more networks may comprise internet, local area network (LAN), wide area network (WAN), telephonic network, cellular network, satellite network, etc.

User(s) of the one or more user devices 110 may specify the information that is needed through one or more applications operating on the user devices 110. In turn, application API calls are then issued through the applications from the user devices 110 to destinations such as the data engine 120 and the database 130. Examples of the one or more user devices 110 may include, but not limited to mobile devices (e.g. smartphones, devices in vehicle and other machine, tablets, notebooks, laptops, personal computers, etc.), and devices not designed for mobility (e.g. desktop computers, information kiosks, televisions, etc.) that are capable of wired or wireless communication.

The data engine 120 is a proxy service that facilitates performance of data operations between the one or more user devices 110 and the database 130. For example, receiving an SQL query from a user device 110 and communicating the query for a data operation to be performed by the database 130 (e.g. data retrieval). The data engine 120 may be implemented on a platform comprising one or more servers, and may include components such as, but not limited to, a processor 122, an application programming interface (API) 124, one or more caches 126, a candidate list structure 128, etc.

The API 124 receives requests/calls (queries) from the one or more user devices 110 (e.g. through applications executed on the one or more user devices 110) for performing data operations such as, but not limited to, data storing and retrieval in association with the data engine 120 and the database 130. The one or more caches 126 are wire protocol-compatible database caches that ensure effective communication/interoperability between the one or more user devices 110 and the database 130.

In some embodiments, the one or more caches 126 are memory caches for storing/caching queries, query hashes, and query results received from the database 130 for future retrieval. Only queries that have been determined to be frequently accessed (e.g., executed more than once) are stored/cached in the one or more caches 126. In response to receiving an API call for a data operation (query) from the one or more user devices 110 at the API 124, the processor 122 first checks the one or more caches 126 to determine whether the same query and results associated with the query have already been cached. If the processor 122 determines that the results of the data operation are cached in the one or more caches 126, then the processor 122 retrieves the results from the one or more caches 126 without needing to access the database 130 to perform query parsing and retrieve such results. By so doing, response time is significantly improved while computational resources wasted through parsing and data manipulation/processing of the same queries can be reduced.

Communications between the one or more user devices 110, the data engine 120, and the database 130 are facilitated via one or more networks. The one or more networks may comprise internet, local area network (LAN), wide area network (WAN), telephonic network, cellular network, satellite network, etc., utilizing any transmission protocols such as, but not limited to, Hypertext Transfer Protocol (HTTP), HTTP Secure (HTTPS), Transmission Control Protocol (TCP), File Transfer Protocol (FTP), FTP Secure (FTPS), SSH FTP (SFTP), Trivial File Transfer Protocol (TFTP), etc.

In some embodiments, the query cache management system 100 employs a repetition graduation architecture that distinguishes between one-time queries and repeating queries through a two-tier approach. The candidate list structure 128 serves as a preliminary storage for query hashes of queries that have been executed once but not yet repeated. The candidate list structure 128 acts as a filter to prevent one-time queries from consuming valuable space in the one or more caches 126 (e.g., while allowing genuinely repeating queries to graduate to the cache 126 upon their second execution).

The candidate list structure 128 may be implemented using various data structures depending on the specific requirements of the system. In some embodiments, the candidate list structure 128 may be implemented as a Bloom filter, which provides memory-efficient storage and probabilistic lookup operations. The Bloom filter implementation allows the system to store a large number of query hashes in a compact memory footprint. Since elements can’t be deleted, when the Bloom filter becomes saturated, the system may periodically delete and rebuild the filter.

In some embodiments, the candidate list structure 128 may be implemented as a hash map that provides exact lookup operations and allows for deletion of individual entries. This configuration offers improved functionality for tracking query behavior and supports selective deletion of entries, making the design appropriate for systems requiring detailed query management.

In some other embodiments, the candidate list structure 128 may be structured as a secondary cache (e.g., a cache 126 that differs from the query cache). The secondary cache may utilize automatic eviction policies, such as time-to-live value/expiration, to automatically evict old query hashes that are unlikely to be repeated. This ensures that stale or infrequently accessed query hashes are removed efficiently, reducing memory consumption and maintaining cache relevance. Additionally, the TTL value can be dynamically adjusted based on observed query patterns or system performance metrics, enabling adaptive cache management. In some embodiments, the secondary cache Each of these embodiments offers distinct benefits in terms of memory efficiency, query tracking, and adaptability.

The one or more caches 126 store query results and query hashes for queries that have demonstrated repetition by: (i) appearing in the candidate list structure; and (ii) being executed more than once. This graduation process ensures that only queries with proven repetition patterns are allowed to consume the resource of the cache. In some embodiments, cache 126 may employ cache management strategies (e.g., Least Recently Used (LRU) eviction) in managing cached entries.

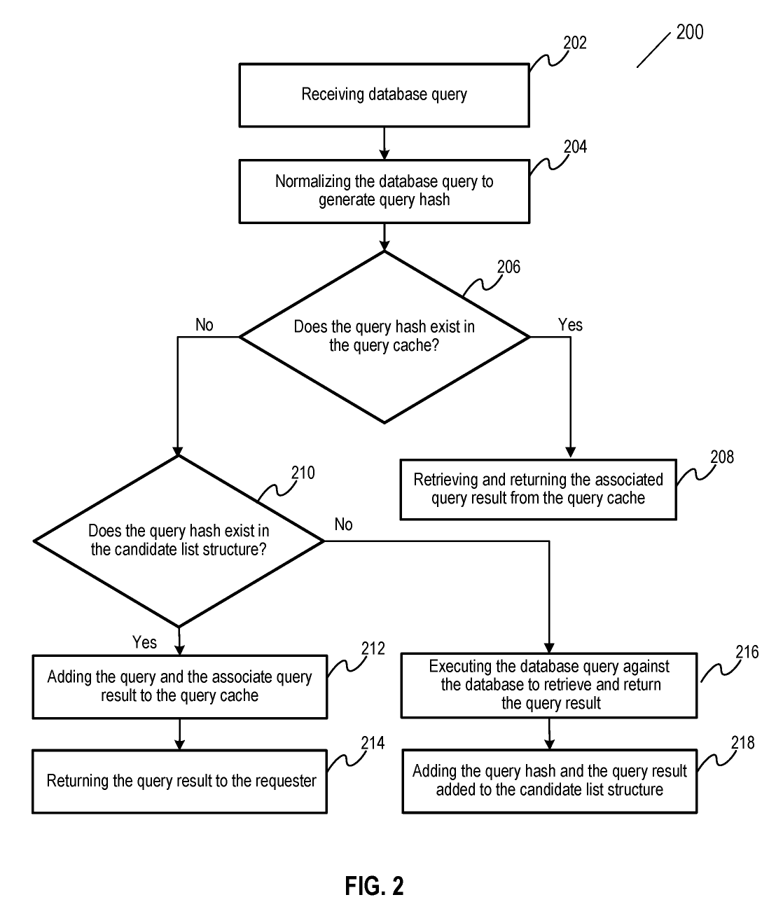

FIG. 2 illustrates an example of query cache handling process 200 in accordance with some embodiments described herein. As illustrated in FIG. 2, the query cache handling process 200 may be performed by the query cache management system 100 to provide efficient query handling by emphasizing cache usage for repeating queries while reducing resource consumption for one-time queries. As illustrated in FIG. 2, process 200 may include a series of blocks for managing database queries and their associated results to be performed by the query cache management system 100. In particular, the process begins at block 202 where a database query is received by the query cache management system 100.

At block 204, the received database query is normalized to generate a query hash. The query hash serves to identify the structure and parameters of the query, thereby facilitating efficient lookup and management within the query cache. The system then checks whether the generated query hash exists in the query cache at block 206. If the query hash is found, the query cache management system 100 then retrieves the associated query result from the query cache and returns the result to the requester without executing the query against the database at block 208. By so doing, response time is significantly improved, and unnecessary resource consuming database operations are avoided through direct query result retrieval from the query cache.

However, if the query hash is not found in the query cache, the process then proceeds to block 210 to determine whether the query hash exists in a candidate list structure. The candidate list structure serves as a preliminary storage for query hashes corresponding to queries that have only been executed once and not yet promoted to the query cache. When the query hash is present in the candidate list structure, the query cache management system 100 then adds the query, the query hash, and the associate query result to the query cache at block 212. This effectively graduates the query from the candidate list structure to the query cache. Thereafter, the system returns the query result to the requester at block 214.

Conversely, if the query hash does not exist in the candidate list structure at block 210, the system determines that the query is being executed for the first time. In this case, the query cache management system 100 executes the query against the database to retrieve and return the query result at block 216. Subsequently, the query, the query hash and the query result are added to the candidate list structure for potential future caching if the query is repeated at block 218. The query cache handling process 200 supports efficient query handling by emphasizing cache usage for repeating queries while reducing resource consumption for one-time queries.

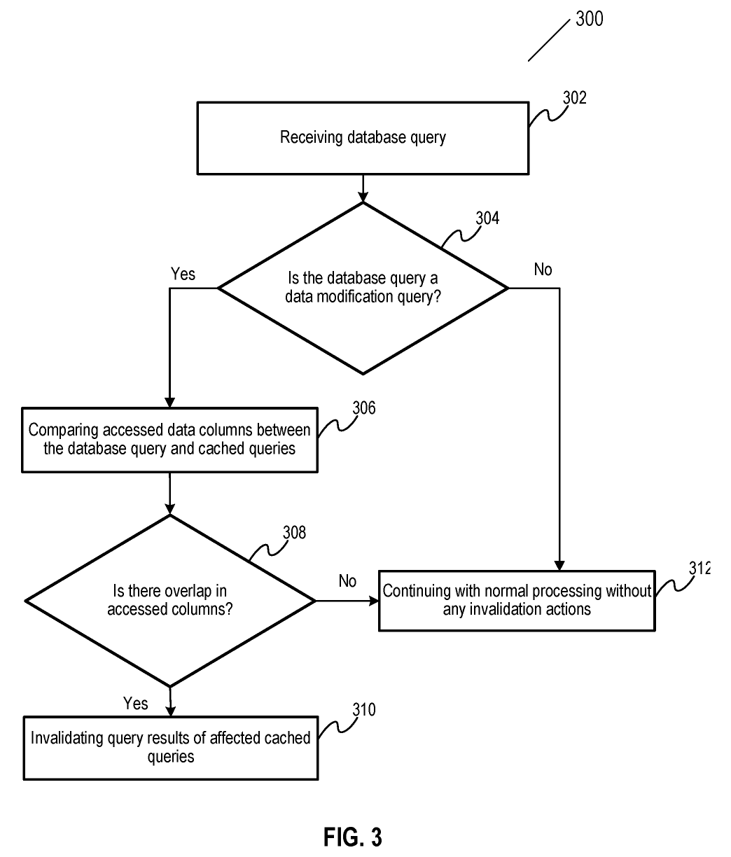

FIG. 3 illustrates an example query invalidation process 300 in accordance with some embodiments described herein. As illustrated in FIG. 3, the query invalidation process 300 may be performed by the query cache management system 100 to ensure that cached query results remain consistent with the underlying database by invalidating affected entries when data modification queries are executed. The process begins when a database query is received at block 302. Accordingly, at block 304, the system evaluates whether the received query corresponds to a data modification query which has the potential to alter the underlying data accessed by cached queries. The data modification query may be a query such as an INSERT, UPDATE, or DELETE operation. If the query is not a data modification query, then processing of the query proceeds as usual without any invalidation actions at block 312. By so doing, read-only queries (e.g., SELECT statements) do not trigger unnecessary invalidation operations.

However, if the query is determined to be a data modification query, the query cache management system 100 proceeds to block 306 where the accessed data columns of the data modification query are compared with those of the cached queries. Specifically, this comparison identifies potential overlaps in the data accessed by the modification query and the cached queries. For example, overlap exists between a database query A and cached query B where query A accesses data column 2 (A: c1=2) and query B accesses data columns 2 and 3 (B: c1=2 and c2=3). At block 308, the system evaluates whether any such overlap exists. If no overlap is detected, the query cache management system 100 concludes that the data modification query does not affect any cached query results, and standard processing resumes at block 312.

Conversely, if an overlap is identified, the query cache management system 100 advances to block 310, where the query results of the affected cached queries are invalidated. For example, the invalidation process may involve removing the affected entries from the cache or marking them as invalid for subsequent retrieval. As a result, stale or inconsistent data will not be returned in response to future queries. The process concludes after either invalidating the affected cached queries or determining that no invalidation is necessary, ensuring the cache remains consistent with the underlying database. By directing invalidation efforts solely toward relevant cached queries, this process 300 enhances cache management and minimizes computational overhead.

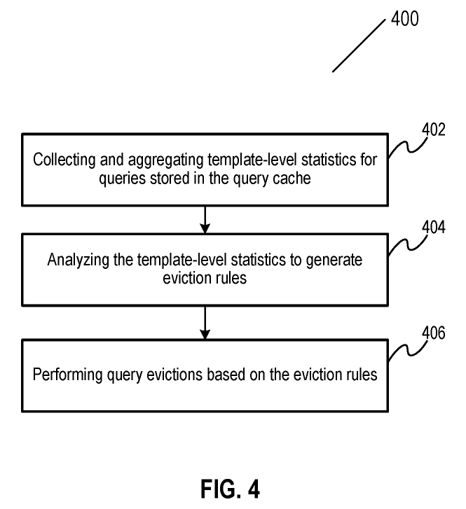

FIG. 4 illustrates an example query eviction process 400 in accordance with some embodiments described herein. As illustrated in FIG. 4, the query eviction process 400 operates within a query cache management system 100 and ensures efficient cache utilization by removing queries that are unlikely to be reused from the cache, based on template-level statistical analysis and eviction rules. The process 400 begins at block 402 where the query cache management system 100 collects and aggregates template-level statistics for queries stored in the query cache. Specifically, the process 400 gathers data on query execution patterns and groups similar queries at the template level to identify broader behavioral trends. In some embodiments, query hashes are first generated from the queries before template-level aggregation is performed. By leveraging historical data, block 402 provides a comprehensive view of query usage patterns over time. Example data gathered may include, but not limited to:
1. template_hash: a unique identifier computed from the structural components of a query with parameterized values abstracted. The identifier enables aggregation of behavioral statistics across structurally similar queries and grouping the queries/query hashes into templates.
2. avg_repetitions_per_query: an arithmetic mean of repetition counts observed for individual queries within a template.
3. max_repeitions_per_query: maximum observed repetition count for any query within a template. In some embodiments, repetition counters for individual queries may be set based on the maximum repetitions observed for their templates in the historical data to provide counter-based eviction.
4. avg_time_between_events: an arithmetic mean of time intervals between successive occurrences of queries belonging to the same template. This establishes expected query recurrence timing.
5. max_time_between_events: maximum observed time interval between successive query occurrences within a template. This establishes an upper bound for detection of query staleness.

Following the aggregation of statistics, the query cache management system 100 analyzes the template-level statistics to generate eviction rules at block 404. During this phase, the aggregated data is processed to derive one or more rules that determine which queries are to be evicted from the cache. These rules may include thresholds for repetition rates, maximum allowable intervals between executions, or other metrics indicative of future reuse likelihood. As a result, eviction decisions are informed by long-term behavioral insights rather than short-term activity spikes.

In some embodiments, collecting and aggregating the template-level statistics for the queries stored in the query cache may include grouping the queries/query hashes into templates based on structural similarity between queries/query hashes, and calculating average query repetitions for each query within each template. The query cache management system 100 then generates or selects one or more query eviction rules based on the calculated average query repetitions. For example, performing query eviction on any query where average query repetitions for the query is below a threshold repetitions level of a template that the query is associated with.

In some embodiments, collecting and aggregating the template-level statistics for the queries stored in the query cache may include grouping the queries/query hashes into templates based on structural similarity between queries/query hashes, and calculating maximum query repetitions for each query within each template. The query cache management system 100 then generates or selects one or more query eviction rules based on the calculated maximum query repetitions. For example, performing query eviction on any query where maximum query repetitions for the query exceeds a threshold repetitions value of a template that the query is associated with.

In some embodiments, collecting and aggregating the template-level statistics for the queries stored in the query cache may include grouping the queries/query hashes into templates based on structural similarity between queries/query hashes, and calculating average time between query executions for each query within each template. The query cache management system 100 then generates or selects one or more query eviction rules based on the average time between query executions. For example, performing query eviction on any query average time between query executions for the query exceeds a time threshold of a template that the query is associated with.

In some embodiments, collecting and aggregating the template-level statistics for the queries stored in the query cache may include grouping the queries/query hashes into templates based on structural similarity between queries/query hashes, and calculating maximum time between query executions for each query within each template. The query cache management system 100 then generates or selects one or more query eviction rules based on the calculated maximum time between query executions. For example, performing query eviction on any query where maximum time between query executions for the query exceeds a time threshold of a template that the query is associated with.

In some example embodiments, a configurable safety factor may be applied to the aggregated template-level statistics in making eviction decisions. For example, queries may be evicted when their time since last execution exceeds the maximum time between repetitions for their template, and multiplied by the safety factor. For example, the safety factor may be a numerical multiplier such as 1.5, 2, 3, etc. This helps maintain cache efficiency by removing queries that are statistically unlikely to be repeated.

Once the eviction rules are established, the query cache management system 100 performs query evictions based on the generated rules at block 406. In response to the identified criteria, queries that meet the eviction conditions are removed from the cache. By doing so, process 400 optimizes cache space utilization, prioritizing the retention of queries with higher reuse potential while evicting those with low repetition likelihood or outdated relevance. By systematically applying the foregoing phases, the query cache management system maintains an efficient and relevant cache, reduces computational overhead, and improves overall system performance.

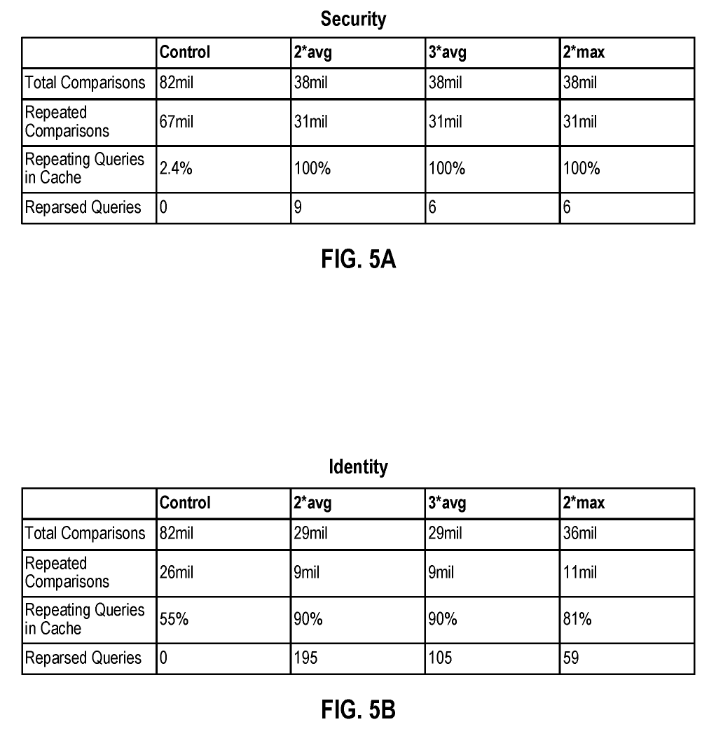

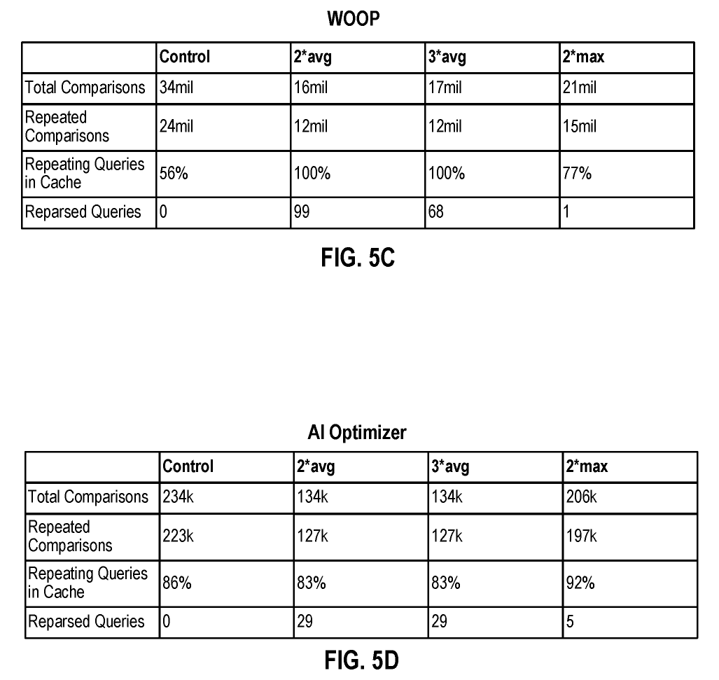

FIGS. 5A-5D illustrate example eviction results in accordance with some embodiments described herein. The query cache management system may be integrated with various database systems and architectures. FIGS. 5A-5D demonstrate validations of the query eviction process 400 across four distinct database workload environments respectively: Security, Identity, WOOP, and AI Optimizer. Each workload environment represents a different operational context and query pattern profile. The Security environment comprises database operations that support a security offering that performs image scanning and vulnerability detection. The Identity environment comprises database operations related to identity management services (e.g., profile retrieval, credential validation). The WOOP environment represents a mixed operational workload that comprises both repetitive transactional queries and variable analytical queries (56% repeating queries in control). The AI Optimizer environment comprises database operations that support machine learning and optimization workloads, and is characterized by iterative query patterns with high repetition rates (86% repeating queries in control).

Results are provided for control and three separate eviction rules derived based on the query eviction process 400. Specifically:

2*avg: evict templates with no repetitions after 6 hours, and any query that was seen last more the 2 average times between repetitions of its template.

3*avg: evict templates with no repetitions after 6 hours, and any query that was seen last more the 3 average times between repetitions of its template.

2*max: evict templates with no repetitions after 6 hours, and any query that was seen last more the 2 maximum times between repetitions of its template.

As illustrated in FIGS. 5A-5D, clean up/query eviction is not performed under control. 2*avg provides a more aggressive form of query eviction, which occasionally removes queries that do repeat. 2*max provides the least aggressive for of query eviction among the three eviction rules, which results in lower query reparsing/false evictions.

In some embodiments, the system may be configured to aggregate data from a database system, leveraging the database system’s analytical capabilities for statistical processing. The statistics may further include organization identifiers, database identifiers, query type indicators, and template hashes for comprehensive template grouping and analysis of query patterns.

In some embodiments, the system may include a mothership component that performs centralized statistical analysis and provides aggregated data to distributed processor 122s. This architecture allows for system-wide optimization based on global query patterns while maintaining local cache management at individual nodes.

In some embodiments, to minimize computational overhead, eviction/cleanup operations may be performed during existing invalidation scans rather than as separate processes. This integration reduces the frequency of cache traversals and improves overall system efficiency by combining multiple cache maintenance operations into unified procedures.

The foregoing example embodiments may have various benefits and advantages. For example, the systems system separates one-time queries from repeating queries by introducing a candidate list structure, which prevents one-time queries from being stored in the main query cache. This arrangement optimizes cache utilization by ensuring that only queries with a high likelihood of repetition are stored in the query cache, thereby reducing cache pollution and minimizing unnecessary computational overhead. The normalization of database queries into query hashes enables efficient and consistent identification of queries, improving the speed and accuracy of cache lookups. By retrieving query results directly from the cache when a match is found, the system reduces database load and improves query response times.

In addition, the system's ability to compare accessed data columns between a data modification query and cached queries ensures that only overlapping queries are invalidated. This arrangement reduces the computational burden of invalidation processes and maintains the integrity of cached data, enhancing the reliability and performance of the query cache management system.

The collection and aggregation of template-level statistics for queries stored in the query cache enable the system to make informed decisions about query eviction. By analyzing long-term query behavior, the system can generate eviction rules that optimize cache utilization and reduce computational overhead.

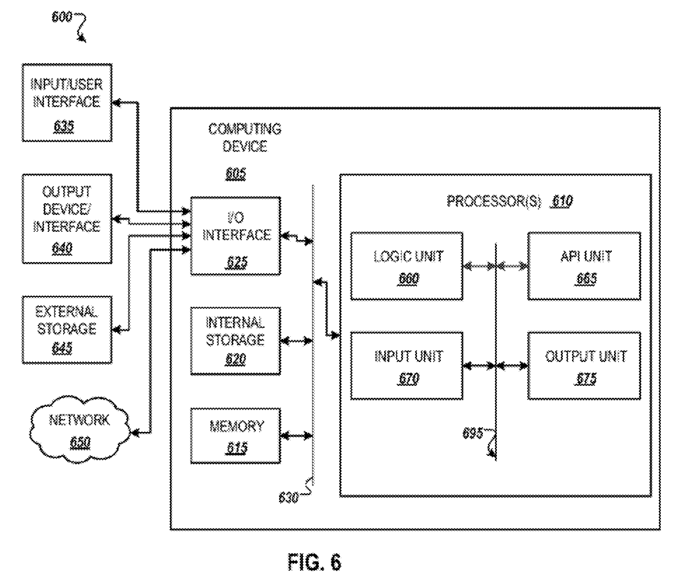

FIG. 6 illustrates an example computing environment with an example computer device suitable for use in some example embodiments. Computer device 605 in computing environment 600 can include one or more processing units, cores, or processors 610, memory 615 (e.g., RAM, ROM, and/or the like), internal storage 620 (e.g., magnetic, optical, solid-state storage, and/or organic), and/or IO interface 625, any of which can be coupled on a communication mechanism or bus 630 for communicating information or embedded in the Computer device 605. IO interface 625 is also configured to receive images from cameras or provide images to projectors or displays, depending on the desired embodiment.

Computer device 605 can be communicatively coupled to input/user interface 635 and output device/interface 640. Either one or both of the input/user interface 635 and output device/interface 640 can be a wired or wireless interface and can be detachable. Input/user interface 635 may include any device, component, sensor, or interface, physical or virtual, that can be used to provide input (e.g., buttons, touch-screen interface, keyboard, a pointing/cursor control, microphone, camera, braille, motion sensor, accelerometer, optical reader, and/or the like). Output device/interface 640 may include a display, television, monitor, printer, speaker, braille, or the like. In some example embodiments, input/user interface 635 and output device/interface 640 can be embedded with or physically coupled to the computer device 605. In other example embodiments, other computer devices may function as or provide the functions of input/user interface 635 and output device/interface 640 for a computer device 605.

Examples of computer device 605 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 605 can be communicatively coupled (e.g., via IO interface 625) to external storage 645 and network 650 for communicating with any number of networked components, devices, and systems, including one or more computer devices of the same or different configuration. Computer device 605 or any connected computer device can be functioning as, providing services of, or referred to as a server, client, thin server, general machine, special-purpose machine, or another label.

IO interface 625 can include but is not limited to, wired and/or wireless interfaces using any communication or IO protocols or standards (e.g., Ethernet, 802.11x, Universal System Bus, WiMax, modem, a cellular network protocol, and the like) for communicating information to and/or from at least all the connected components, devices, and network in computing environment 600. Network 650 can be any network or combination of networks (e.g., the Internet, local area network, wide area network, a telephonic network, a cellular network, satellite network, and the like).

Computer device 605 can use and/or communicate using computer-usable or computer readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory.

Computer device 605 can be used to implement techniques, methods, applications, processes, or computer-executable instructions in some example computing environments. Computer-executable instructions can be retrieved from transitory media and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 610 can execute under any operating system (OS) (not shown), in a native or virtual environment. One or more applications can be deployed that include logic unit 660, application programming interface (API) unit 665, input unit 670, output unit 675, and inter-unit communication mechanism 695 for the different units to communicate with each other, with the OS, and with other applications (not shown). The described units and elements can be varied in design, function, configuration, or embodiment and are not limited to the descriptions provided. Processor(s) 610 can be in the form of hardware processors such as central processing units (CPUs) or in a combination of hardware and software units.

In some example embodiments, when information or an execution instruction is received by API unit 665, it may be communicated to one or more other units (e.g., logic unit 660, input unit 670, output unit 675). In some instances, logic unit 660 may be configured to control the information flow among the units and direct the services provided by API unit 665, the input unit 670, the output unit 675, in some example embodiments described above. For example, the flow of one or more processes or embodiments may be controlled by logic unit 660 alone or in conjunction with API unit 665. The input unit 670 may be configured to obtain input for the calculations described in the example embodiments, and the output unit 675 may be configured to provide an output based on the calculations described in example embodiments.

Processor(s) 610 can be configured to receive database queries as illustrated in FIG. 2. The processor(s) 610 may also be configured to normalize the database query to generate a query hash as illustrated in FIG. 2. The processor(s) 610 may also be configured to determine whether the query hash exists in the query cache as illustrated in FIG. 2. The processor(s) 610 may also be configured to retrieve an associated query result stored in the query cache in response to determining the query hash exists in the query cache as illustrated in FIG. 2. The processor(s) 610 may also be configured to determine whether the query hash exists in a candidate list structure in response to determining the query hash does not exist in the query cache, wherein the candidate list structure is configured to store query hashes for queries that have only been executed once as illustrated in FIG. 2. The processor(s) 610 may also be configured to add the database query and the associated query result to the query cache in response to determining that the query hash exists in the candidate list structure, and retrieve the associated query result as illustrated in FIG. 2.

The processor(s) 610 may also be configured to add the database query and the query hash to the candidate list structure in response to determining that the query hash does not exist in the candidate list structure as illustrated in FIG. 2. The processor(s) 610 may also be configured to determine whether the database query is a data modification query as illustrated in FIG. 3. The processor(s) 610 may also be configured to compare accessed data columns between the database query and queries cached in the query cache in response to determining the database query is a data modification query as illustrated in FIG. 3. The processor(s) 610 may also be configured to invalidate query results of one or more queries cached in the query cache in response to determining overlap in accessed data columns between the database query and the one or more queries as illustrated in FIG. 3.

The processor(s) 610 may also be configured to determine whether the database query modifies query results of one or more queries cached in the query cache as illustrated in FIG. 3. The processor(s) 610 may also be configured to invalidate the query results of the one or more queries in response to determining that the database query modifies the query results of the one or more queries as illustrated in FIG. 3. The processor(s) 610 may also be configured to receive database queries as illustrated in FIG. 3.

The processor(s) 610 may also be configured to determine whether the database query is a data modification query as illustrated in FIG. 3. The processor(s) 610 may also be configured to compare accessed data columns between the database query and the queries cached in the query cache in response to determining the database query is a data modification query as illustrated in FIG. 3. The processor(s) 610 may also be configured to invalidate query results of one or more queries cached in the query cache in response to determining overlap in accessed data columns between the database query and the one or more queries as illustrated in FIG. 3.

The processor(s) 610 may also be configured to normalize the database query to generate a query hash as illustrated in FIG. 2. The processor(s) 610 may also be configured to determine whether the query hash exists in the query cache as illustrated in FIG. 2. The processor(s) 610 may also be configured to retrieve an associated query result stored in the query cache in response to determining the query hash exists in the query cache as illustrated in FIG. 2. The processor(s) 610 may also be configured to determine whether the query hash exists in a candidate list structure in response to determining the query hash does not exist in the query cache, wherein the candidate list structure is configured to store query hashes for queries that have only been executed once as illustrated in FIG. 2. The processor(s) 610 may also be configured to add the database query and the associated query result to the query cache in response to determining that the query hash exists in the candidate list structure, and retrieve the associated query result as illustrated in FIG. 2. The processor(s) 610 may also be configured to add the database query and the query hash to the candidate list structure in response to determining that the query hash does not exist in the candidate list structure as illustrated in FIG. 2.

The processor(s) 610 may also be configured to collect and aggregate template-level statistics for queries stored in a query cache as illustrated in FIGS. 4-5. The processor(s) 610 may also be configured to analyze the template-level statistics to generate one or more eviction rules as illustrated in FIGS. 4-5. The processor(s) 610 may also be configured to perform query evictions to evict one or more queries of the queries based on the one or more query eviction rules as illustrated in FIGS. 4-5. The processor(s) 610 may also be configured to generate a plurality of query hashes from the queries, each query hash corresponds to a query stored in the query cache as illustrated in FIGS. 4-5.

The processor(s) 610 may also be configured to aggregate the plurality of query hashes into a plurality of templates based on structural similarities between query hashes as illustrated in FIGS. 4-5. The processor(s) 610 may also be configured to calculate, for each template of the plurality of templates, average query repetitions for each query within the template as illustrated in FIGS. 4-5. The processor(s) 610 may also be configured to calculate, for each template of the plurality of templates, maximum query repetitions for each query within the template as illustrated in FIGS. 4-5. The processor(s) 610 may also be configured to calculate, for each template of the plurality of templates, average time between query executions for each query within the template as illustrated in FIGS. 4-5. The processor(s) 610 may also be configured to calculate, for each template of the plurality of templates, maximum time between query executions for each query within the template as illustrated in FIGS. 4-5. The processor(s) 610 may also be configured to perform query evictions during invalidation scans to reduce computational overhead as illustrated in FIGS. 4-5.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example embodiments, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system’s registers and memories into other data similarly represented as physical quantities within the computer system’s memories or registers or other information storage, transmission or display devices.

Example embodiments may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer readable storage medium or a computer readable signal medium. A computer readable storage medium may involve tangible mediums such as, but not limited to optical disks, magnetic disks, read-only memories, random access memories, solid-state devices, and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software embodiments that involve instructions that perform the operations of the desired embodiment.

Various general-purpose systems may be used with programs and modules in accordance with the examples herein, or it may prove convenient to construct a more specialized apparatus to perform desired method steps. In addition, the example embodiments are not described with reference to any particular programming language. It will be appreciated that a variety of programming languages may be used to implement the teachings of the example embodiments as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example embodiments may be implemented using circuits and logic devices (hardware), while other aspects may be implemented using instructions stored on a machine-readable medium (software), which if executed by a processor, would cause the processor to perform a method to carry out embodiments of the present application. Further, some example embodiments of the present application may be performed solely in hardware, whereas other example embodiments may be performed solely in software. Moreover, the various functions described can be performed in a single unit, or can be spread across a number of components in any number of ways. When performed by software, the methods may be executed by a processor, such as a general-purpose computer, based on instructions stored on a computer readable medium. If desired, the instructions can be stored on the medium in a compressed and/or encrypted format.

Moreover, other embodiments of the present application will be apparent to those skilled in the art from consideration of the specification and practice of the teachings of the present application. Various aspects and/or components of the described example embodiments may be used singly or in any combination. It is intended that the specification and example embodiments be considered as examples only, with the true scope and spirit of the present application being indicated by the following claims.

What is claimed is:

1. A query cache management system comprising:
a query cache configured to store query results and query hashes for queries that have been executed multiple times;
a processor in communication with the query cache, wherein the processor is configured to:
receive database queries; and
for each database query received:
normalize the database query to generate a query hash,
determine whether the query hash exists in the query cache,
retrieve an associated query result stored in the query cache in response to determining the query hash exists in the query cache,
determine whether the query hash exists in a candidate list structure in response to determining the query hash does not exist in the query cache, wherein the candidate list structure is configured to store query hashes for queries that have only been executed once, and
add the database query and the associated query result to the query cache in response to determining that the query hash exists in the candidate list structure, and retrieve the associated query result.

2. The system of claim 1, the processor is further configured to:
add the database query and the query hash to the candidate list structure in response to determining that the query hash does not exist in the candidate list structure.

3. The system of claim 2, wherein the candidate list structure comprises at least one of a bloom filter or a hash map.

4. The system of claim 2, wherein the candidate list structure comprises a secondary cache.

5. The system of claim 4, wherein the secondary cache is configured to automatically evict stored query hashes according to a time-to-live value.

6. The system of claim 2, wherein the processor is further configured to:
determine whether the database query is a data modification query;
compare accessed data columns between the database query and queries cached in the query cache in response to determining the database query is a data modification query; and
invalidate query results of one or more queries cached in the query cache in response to determining overlap in accessed data columns between the database query and the one or more queries.

7. The system of claim 2, wherein the processor is further configured to:
determine whether the database query modifies query results of one or more queries cached in the query cache; and
invalidate the query results of the one or more queries in response to determining that the database query modifies the query results of the one or more queries.

8. A query cache management system comprising:
a query cache configured to store query results and query hashes for queries that have been executed multiple times;
a processor in communication with the query cache, wherein the processor is configured to:
receive database queries;
for each database query received:
determine whether the database query is a data modification query;
compare accessed data columns between the database query and the queries cached in the query cache in response to determining the database query is a data modification query; and
invalidate query results of one or more queries cached in the query cache in response to determining overlap in accessed data columns between the database query and the one or more queries.

9. The system of claim 8, wherein the processor is further configured to:
normalize the database query to generate a query hash;
determine whether the query hash exists in the query cache;
retrieve an associated query result stored in the query cache in response to determining the query hash exists in the query cache;
determine whether the query hash exists in a candidate list structure in response to determining the query hash does not exist in the query cache, wherein the candidate list structure is configured to store query hashes for queries that have only been executed once; and
add the database query and the associated query result to the query cache in response to determining that the query hash exists in the candidate list structure, and retrieve the associated query result.

10. The system of claim 9, the processor is further configured to:
add the database query and the query hash to the candidate list structure in response to determining that the query hash does not exist in the candidate list structure.

11. The system of claim 10, wherein the candidate list structure comprises a bloom filter or a hash map.

12. The system of claim 10, wherein the candidate list structure comprises a secondary cache.

13. The system of claim 12, wherein the secondary cache is configured to automatically evict stored query hashes according to a time-to-live value.

14. A query cache optimization method, the method comprising:
collecting and aggregating, by a processor, template-level statistics for queries stored in a query cache;
analyzing, by the processor, the template-level statistics to generate one or more query eviction rules; and
performing, by the processor, query evictions to evict one or more queries of the queries based on the one or more query eviction rules.

15. The method of claim 14, wherein the collecting and aggregating the template-level statistics for the queries stored in the query cache comprise:
generating a plurality of query hashes from the queries, each query hash corresponds to a query stored in the query cache; and
aggregating the plurality of query hashes into a plurality of templates based on structural similarities between query hashes.

16. The method of claim 15,
wherein the collecting and aggregating the template-level statistics for the queries stored in the query cache further comprise calculating, for each template of the plurality of templates, average query repetitions for each query within the template,
wherein the one or more query eviction rules comprise performance of query eviction on a query where average query repetitions for the query is below a threshold repetitions level of a template that the query is associated with.

17. The method of claim 15,
wherein the collecting and aggregating the template-level statistics for the queries stored in the query cache further comprise calculating, for each template of the plurality of templates, maximum query repetitions for each query within the template,
wherein the one or more query eviction rules comprise performance of query eviction on a query where maximum query repetitions for the query exceeds a threshold repetitions value of a template that the query is associated with.

18. The method of claim 15,
wherein the collecting and aggregating the template-level statistics for the queries stored in the query cache further comprise calculating, for each template of the plurality of templates, average time between query executions for each query within the template,
wherein the one or more query eviction rules comprise performance of query eviction on a query where average time between query executions for the query exceeds a time threshold of a template that the query is associated with.

19. The method of claim 15,
wherein the collecting and aggregating the template-level statistics for the queries stored in the query cache further comprise calculating, for each template of the plurality of templates, maximum time between query executions for each query within the template,
wherein the one or more query eviction rules comprise performance of query eviction on a query where maximum time between query executions for the query exceeds a time threshold of a template that the query is associated with.

20. The method of claim 14, wherein the query evictions are performed during invalidation scans to reduce computational overhead.
